(19) United States
(12) Patent Application Publication
(10) Pub. No.: US 2002/0032905 A1
(43) Pub. Date: Mar. 14, 2002

(54) Online digital video signal transfer apparatus and method

(76) Inventors: Scott Jeffrey Sherr, Los Angeles, CA (US); Eva Miranda, Saratoga, CA (US); Ira Steven Rubenstein, Los Angeles, CA (US); Sean Brennan Carey, Marina del Rey, CA (US); Yair Landau, Pacific Palisades, CA (US); Andrew C. Frank, New York, NY (US); Brian David Lakamp, Malibu, CA (US); Bryan Gentry Spaulding, San Francisco, CA (US); Charles Jonathan Evans, New York, NY (US); Everton Anthony Schnabel, Los Angeles, CA (US); Hartmut Ochs, Los Angeles, CA (US); Jeremy Eli Barnett, Pacific Palisades, CA (US); Seth David Palmer, New York, NY (US); Todd Michael Henderson, Los Angeles, CA (US); William W. Chong, New York, NY (US); Bruce Forest, Weston, CT (US); Steven Koenig, Menlo Park, CA (US); Karl Wiersholm, Kirkland, WA (US)

Correspondence Address: Ted R. Rittmaster, FOLEY & LARDNER, 2029 Century Park East - Suite 3500, Los Angeles, CA, 90067-3021, US

(21) Appl. No.: 09/826,374

(22) Filed: Apr. 4, 2001

Related U.S. Application Data
(60) Provisional application No. 60/195,870, filed on Apr. 7, 2000.

(51) Int. Cl. G06F 3/00; H04N 5/445

(52) U.S. Cl. 725/38

(57) ABSTRACT

The present invention overcomes the problems in the existing art described above by providing an online digital video signal transfer apparatus and method. Rental of the digital video signals occurs within an online environment including one or more client computers and at least one network server connected by a communications link to the one or more client computers. The method includes providing access to an online catalog stored within a memory of a network video server computer. The online catalog includes information regarding digital video signals available for rental from the network server computer. Requests are then received from client computers for rental of digital video signals selected from the online catalog for a specified period of time. The requests include electronic payment based on the selected digital video signal and the specified period of time. Once electronic payment is provided, the digital video signal is transmitted to the client computer via communications link. Once transmitted, the digital video signal is viewable by a user of the client computer during the specified period of time. Advantages of the invention include the ability to rent motion pictures without having to provide additional monies for purchase of the motion pictures. In addition, the present invention provides an interface that simulates the actual rental of motion pictures within a video rental store. Moreover, during the specified period of rental, the user is allowed to view the motion picture as many times as desired, thereby simulating the actual rental of video cassettes or DVDs of feature length motion pictures.

### RELATED APPLICATIONS

The present invention relates to U.S. Provisional Patent Application Ser. No. 60/195,870, filed Apr. 7, 2000, which is incorporated herein by reference in its entirety and which forms a basis for priority herein. The present invention also relates to U.S. patent application Ser. No. 09/603,805, filed Jun. 20, 2000 (for which a Petition to Convert Non-Provisional Application to Provisional Application Under 37 CFR 1.53(c)(2) was filed Mar. 16, 2001 via U.S. Express Mail Label No. EL752586903US, our file number 041892/0208, decision of petition and provisional serial number unknown at this time), is incorporated herein by reference.

### BACKGROUND OF THE INVENTION

1. Field of the Invention

The invention relates generally to the field of electronic commerce. More particularly, the invention relates to an online digital video signal transfer method and apparatus enabling online rental of digitally encoded motion pictures.

2. Description of Related Art

The Internet has provided consumers with a new medium for commerce, commonly referred to as electronic commerce (or Ecommerce). Currently there exists several Internet services that provide consumers with access to motion pictures that may be ordered and downloaded online.

Tranz-Send Business Network (TSBN) is an online provider of video-on-demand (VOD) motion pictures. TSBN has created a complete end-to-end web based video-on-demand solution that delivers full screen broadcast quality electronic content to the end user on demand. However, a user has relatively little control over VOD movies such as pause and rewind features. In addition, a fee is required each time the user desires to view the movie once the broadcast is complete.

Consequently, TSBN does not provide users with the capability for online rental of motion pictures for a fixed period, such that during the fixed period the user is allowed to replay the motion picture as many times as desired. Moreover, TSBN does not provide an interface that simulates the rental of motion pictures from racks of aisles within a video rental store.

Therefore, there remains a need to overcome the limitations on the above described existing art which is satisfied by the inventive structure and method described hereinafter.

### SUMMARY OF THE DISCLOSURE

Embodiments of the present invention overcome the problems in the existing art described above by providing an online digital video signal transfer apparatus and method. Rental of the digital video signals occurs within an online environment including one or more client computers and at least one network server connected by a communications link to the one or more client computers. A method according to an embodiment of the invention includes providing access to an online catalog stored within a memory of a network video server computer. The online catalog includes information regarding digital video signals available for rental from the network server computer. Requests are then received from client computers for rental of digital video signals selected from the online catalog for a specified period of time. The requests include electronic payment based on the selected digital video signal and the specified number of plays and/or the period of time. Once electronic payment is provided, the digital video signal is transmitted to the client computer via communications link. Once transmitted, the digital video signal is viewable by a user of the client computer during the specified period of time.

Advantages of the invention include the ability to rent motion pictures without having to provide additional monies for purchase of the motion pictures. In addition, the present invention provides an interface, which simulates the actual rental of motion pictures within a video rental store. Moreover, in further embodiments, during the specified period of rental, the user is allowed to view the motion picture as many times as desired, thereby simulating the actual rental of feature length motion pictures. In other embodiments, the user is allowed to view the motion picture a predetermined number of times during an unspecified period of rental.

### BRIEF DESCRIPTION OF THE DRAWINGS

The present invention is illustrated by way of example, and not by way of limitation, in the figures of the accompanying drawings and in which:

FIG. 1 is a simplified view of an exemplary client-server environment in which the present invention may be implemented.

FIG. 2 depicts an exemplary high-level system architecture implementation of the present invention.

FIG. 3 is a block diagram of the client computer and the network video server as shown in FIG. 2.

FIG. 4 depicts an exemplary online video transfer site screen that enables online rental of digital video signals according to one embodiment of the present invention.

FIG. 5 depicts a listing of digital video signals designated by the user as being of interest during a previous visit to the web site according to one embodiment of the present invention.

FIG. 6 depicts a listing of recommendations for movies to download from the web site according to one embodiment of the present invention.

FIG. 7 depicts a quick pick feature screen on the web site according to one embodiment of the present invention.

FIGS. 8-11 depict exemplary online video transfer site screens that enable online rental of digital video signals according to one embodiment of the present invention.

FIG. 12 depicts a license access level selection screen according to one embodiment of the present invention.

FIGS. 13-15 are flow diagrams illustrating online rental of digital video signals according to exemplary embodiments of the present invention.

### DETAILED DESCRIPTION OF VARIOUS EMBODIMENTS

Embodiments of the present invention overcome the problems in the existing art described above by providing an online digital video signal transfer apparatus and method, for example enabling online rental, purchase and/or delivery of digitally encoded motion pictures. Systems and processes according to embodiments of the present invention provide a content owner or holder with a mechanism for controlling distribution of content to users by allowing users to access the content through a network. One example model for the system and process is a movie rental system for downloading movie files to customers across the Internet. Other embodiments may involve delivery of other types of content including, but not limited to, music files, still image files, game programs, other software or data, and combinations thereof. Moreover, other embodiments may employ distribution of encoded physical media, or wide area or local area networks. For purposes of simplifying the present disclosure, embodiments described herein are primarily with reference to a movie rental service. However, it will be readily understood that aspects of the invention may be employed in other suitable content delivery applications as noted above.

In the following description, reference is made to the accompanying drawings which form a part hereof, and in which is shown by way of illustration specific embodiments in which the invention may be practiced. It is to be understood that other embodiments may be utilized and structural changes may be made without departing from the scope of the various embodiments of the present invention.

In one embodiment, a movie transfer apparatus and method provides data stored on a computer system to a user across a network connection. The transfer may be accomplished in various ways, including, but not limited to, download to memory storage, streaming video, audio, or a combination, across various types of connections, including, but not limited to, the Internet, private or public networks, direct wire or fiber connections, wireless connections, broadcast systems (e.g., cable systems, satellite systems, broadcast television system, broadcast digital television systems) or a combination of connections. In other embodiments the movie is encoded on tangible media and physically distributed.

Further embodiments of the invention relate to aspects of handling electronic files. For clarity, the description focuses on implementations for digital data signals comprising video and audio information which include digitally encoded movies (referred to as “movies” or “videos”). However, many or all of the methods and apparatus described may be readily adapted to apply to electronic files of other types as well, such as digitally encoded songs, books, television programming, radio programming, and any other content (audio, video, text, etc.) which may be digitized or encoded and stored as an electronic file. Also, control information including, but not limited to, video aspect ratio, resolution, and audio playback parameters may also be included in the electronic file.

Some embodiments of the invention relate to implementations for a network movie (hereafter “video”) server computer system accessible through the World Wide Web and the Internet as a website (referred to as the “main website”). However, many or all of the methods and apparatus described may be readily adapted to other data connections as well, including, but not limited to, other Internet connection interfaces (e.g., an FTP server), private networks (e.g., a network provided by an ISP for its subscribers), and direct connections (such as a directly wired set of stations in a limited area such as a hotel).

In addition, further embodiments relate to implementations where the user accesses and downloads electronic files using a computer system. However, many or all of the methods and apparatus described may be readily adapted to other network enabled devices which the user may use to access and download data from the server as well, such as a set-top box, or a television, with a connected telephone, or cable modem and available storage memory (such as a hard disk), or some other device with a network connection which may access the server and a storage device for storing a downloaded file. Additional variations may also be implemented such as interfaces for wireless telephones, set-top-boxes, PDAs, AVHDD devices (such as a SONY “Tivo” device), and for satellite download capability.

Any necessary adaptations will be apparent to those of ordinary skill in the art. The movie transfer system may be implemented in hardware, software, or a combination of both.

In addition, as will be described in greater detail below, some embodiments of the present invention include features that seek to simulate the traditional rental of motion pictures from a video rental store. According to one embodiment, rental of the digital video signals occurs within an online environment including at least one network server located at a first node and connected by a communications link to a plurality of client computers or other user network devices located at other nodes. The method includes providing access to an online catalog stored within a memory of a network video server computer. The online catalog includes information regarding digital video signals available for rental from the network server computer. Requests are then submitted by client computers for rental of digital video signals selected from the online catalog for a specified period of time or for a specified number of plays. The requests include electronic payment based on the selected digital video signal and the specified period of time or for a specified number of plays. Once electronic payment is provided, the digital video signal is transmitted to the client computer via a communications link. Once transmitted, the digital video signal is viewable by a user of the client computer during the specified period of time.

In one embodiment, the client computer establishes electronic communication prior to permitting viewing of the digital video signal to ensure playback is within the specified rental parameters, and optionally that the machine used for playback is the machine that will be used for viewing. This ensures that video downloads are not conveyed to other parties who may also wish to view the movie. In that event, the server provides the new party the opportunity to purchase a rental license.

In one embodiment, functions are implemented with machine-executable instructions. The instructions may be used to cause a general-purpose or special-purpose processor that is programmed with the instructions to perform the functions and steps described herein. Alternatively, the functions and steps may be performed by specific hardware components that contain hardwired logic for performing the steps, or by any combination of programmed computer components and custom hardware components.

Embodiments of the present invention may be implemented as a computer program product which may include a machine-readable medium having stored thereon instructions which may be used to program a computer (or other electronic devices) to perform a process according to embodiments of the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, embodiments of the present invention may also be implemented as a computer program product, wherein the program may be transferred from a remote computer (e.g., a server) to a requesting computer (e.g., a client) by way of data signals embodied in a carrier wave or other propagation medium via a communication link (e.g., a modem or network connection).

System Architecture

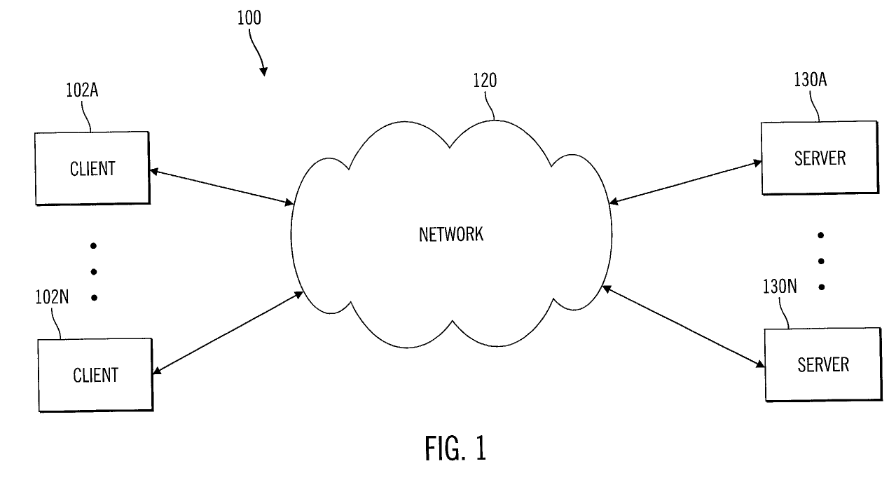

FIG. 1 is a simplified view of an exemplary client-server environment 100, such as the World Wide Web (the Web), in which the online digital video transfer method and apparatus may be implemented. The architecture of the Web follows a conventional client-server model. The terms “client” and “server” are used to refer to a computer's general role as a submitter of requests for data (the client) or provider of data (the server). Web clients 102 (102A, . . . , 102N) and Web servers 130 (130A, . . . , 130N) communicate using a protocol such as HyperText Transfer Protocol (HTTP). In the Web environment, Web browsers reside on clients and render Web documents (pages) served by the Web servers. The client-server model is used to communicate information between clients 102 and servers 130. Web servers 130 are coupled to a network 120, for example the Internet, and respond to document requests and/or other queries from Web clients. When a user selects a document by submitting its Uniform Resource Locator (URL), a Web browser, such as Netscape Navigator or Internet Explorer, opens a connection to a server 130 and initiates a request (e.g., an HTTP get) for the document. The server 130 delivers the requested document, typically in the form of a text document coded in a standard markup language such as HyperText Markup Language (HTML) or Dynamic HTML (DHTML)

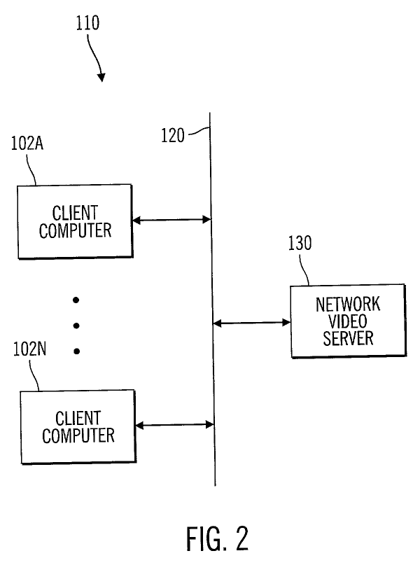

In accordance with the client server environment depicted in FIG. 1, an online digital video signal transfer apparatus 110 may be implemented in an online environment according to a first embodiment of the present invention as depicted in FIG. 2. The online environment includes one or more client computers 102 (102A, 102N) and at least one network server computer 130 connected by a communications link 120 to the plurality of client computers 102. The communications link 120 generally refers to any type of wire or wireless link between computers such as, but not limited to, a local area network, a wide area network, or a combination of networks. In one embodiment of the present invention the communications link may be a network such as the internet.

A client computer 102 may be any type of computing device such as, but not limited to, desktop computers, workstations, laptops, a set-top box, and/or mainframe computers. One or more users not shown may be associated with each client computer 102.

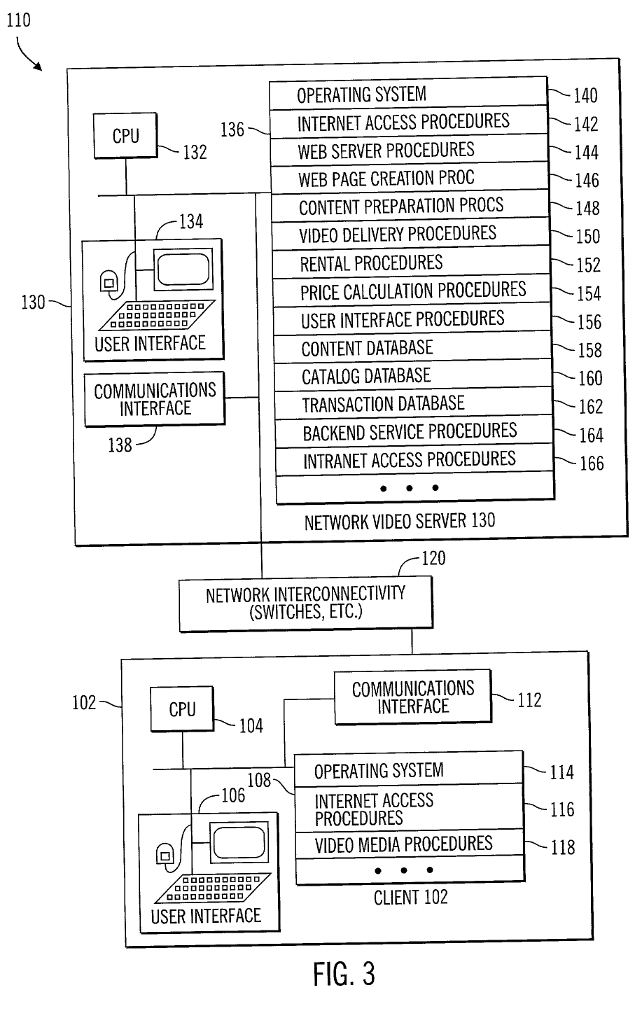

FIG. 3 illustrates the client computer 102 which includes a CPU 104, a user interface 106, a memory 108 and a communications interface 112. The communications interface 112 is used to communicate with a network video server computer 130, or other system resources not shown. The communications interface provides a network connection. While any connection rate may be used, a high speed or broadband data connection, such as a connection providing a data rate of 500 kilobit per second (kbps) or more is preferred. The memory 108 of the client computer 102 may be implemented as RAM (random access memory) or a combination of RAM and non-volatile memory such as, but not limited to, magnetic disk storage. The memory 108 may contain magnetic disk storage sufficient to store an encoded movie, or with at least one gigabyte of free space. The memory 108 may contain the following:

an operating system 114;

internet access procedures 116 including a Web-browser such as, for example, Internet Explorer Version 4.0 or greater;

video media procedures 118;

as well as other procedures and files.

FIG. 3 also illustrates the network video server computer 130 which includes a central processing unit (CPU) 132, a user interface 134, a memory 136, and a communications interface 138. The network video server computer 130 may be any type of computing device such as, but not limited to, desktop computers, work stations, laptops, and/or main frame computers. The communications interface 138 is used to communicate with the client computers 102 as well as other system resources, such as content servers, not shown.

The memory 136 of the network video server computer 130 may be implemented as RAM (random access memory) or a combination of RAM and nonvolatile memory such as magnetic disk storage. Memory 118 may contain the following:

an operating system 140;

internet access procedures 142;

web server procedures 144;

web page creation procedures 146 that dynamically generate user web pages for registered users as well as movie web pages for one or more of the digital video signals available for rental from the network video server computer 130;

content preparation procedures 148, for encoding and encrypting original motion pictures;

video delivery procedures 150 for downloading digital video signals from the network video server computer 130 to the user computers 102;

rental procedures 152 for providing unlock encryption keys enabling viewing of downloaded digital video signals for a specified period of time;

price calculation procedures 154 for calculating and receiving electronic payment from users for a selected digital video signal;

user interface procedures 156 providing access to online catalog information regarding digital video signals available for rental from the network video server computer 130 including a movie search engine;

a content database 158 for storage of encoded and encrypted digital video signals available for download;

a catalog database 160 including information regarding digital video signals available for rental from the network video server computer 130;

a transaction database 162 for storage of information regarding user information as well as transaction information and license keys;

back end service procedures 164;

Intranet access procedures 166; and

Other procedures and data structures.

Exemplary Online Video Transfer Site Interface

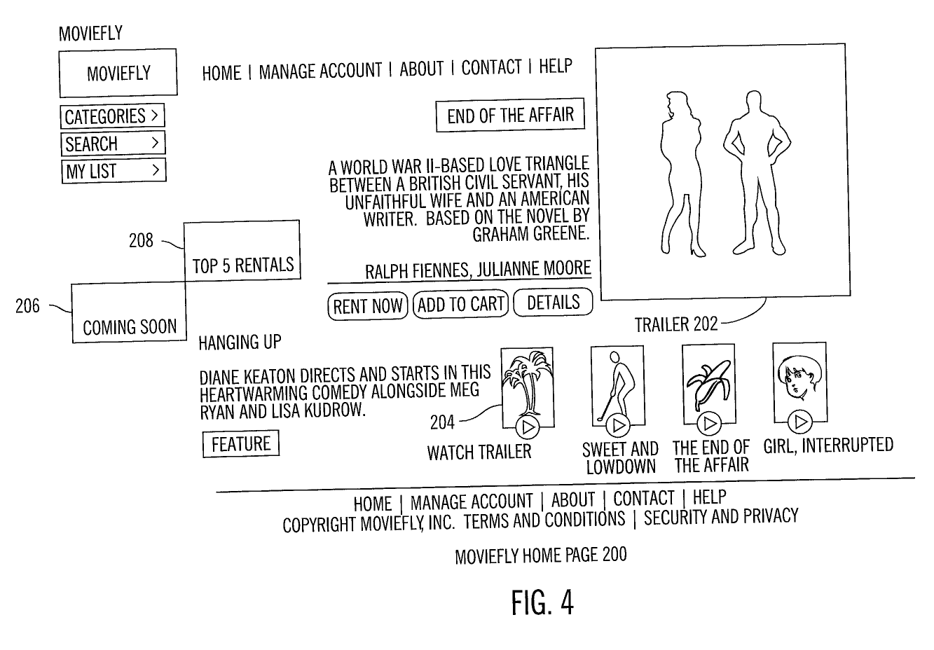

FIG. 4 depicts an exemplary online video transfer site screen that allows online users to rent digital video signals from the network video server computer 130. According to one embodiment, when a user wishes to participate in online rental of digital video signals, for example digitally encoded movies, the online user enters a main website and is presented with the main website home page screen (movie home page) 200. The movie home page 200 provides access to online catalog information regarding various digital video signals available for rental from the network video server computer 130 (e.g., text which is also printed on a video cassette box for the movie, reviews of the movie, or comments from other users). The movie home page 200 also permits playing a trailer 202 of a featured selection 204 and includes additional information such as the coming soon area 206, listing of the top five rentals 208 in clips and stills of various digital video signals available for rental. From the movie home page 200, the online user is forwarded to various screens that allow the user to search and view various digital signals available for rental as well as the capability to download digital video signals for viewing on the user computer 102 at a later time.

As indicated above, the main website home page 200 is the first page presented to a user upon entry into the main website. The home page 200 presents the trailer 202 from a movie selected by the main website operator. The trailer 202 begins playing (i.e., the video sequence begins) when the home page is accessed. The home page 200 also presents several movies to the user, such as by displaying an image and title for each movie, or by displaying an image of the front of a video cassette box for the movie. The home page 200 may also provide categories of information to the user, such as, but not limited to, special or featured movies or a top 10 list of movies.

The user may also access additional information about a movie through the video box, such as by mouse-clicking on the box or by selecting a command from a menu. The main website provides a distinction between selecting a movie for a commercial transaction and for accessing additional information, such as by right-click versus left-click or distinct menu commands. Upon accessing additional information for a movie, the website optionally begins playing the trailer for or a clip from the movie. Examples of additional information available include images and audio from the movie, images and text from the video cassette box, reviews of the movie (for example, by staff of the movie website, by third parties, by users of the movie website), or other links to websites related to the movie (for example, a page in a movie index website, the official website for the movie sponsored by the owner of the movie, or the official website for the soundtrack of the movie).

In one embodiment, a visual representation of the user's selection of services with respect to movies may be provided on the main website. This visual representation may have various information and formats such as, but not limited to, a table by movie for rental, purchase, recommendation, or remember. Services may be represented by graphical icons as well as by text.

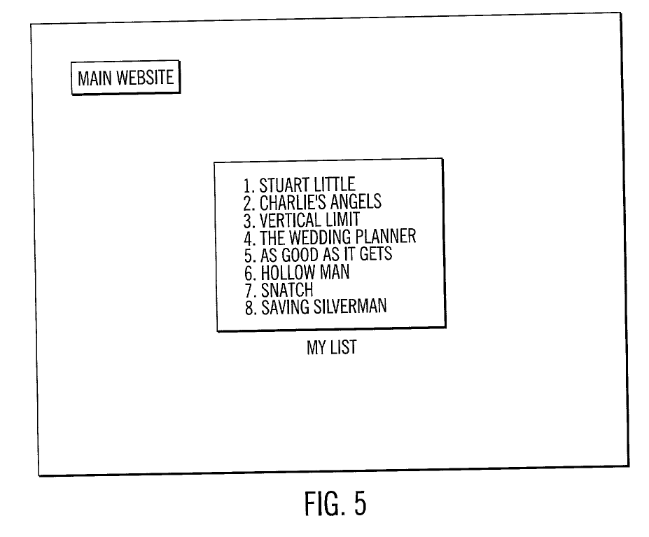

The content of the movie home page 200 or other pages may be customized to the user. For example, in one embodiment, a “Remember Engine” may be used to preserve a list of one or more movies designated by a user as being of interest during a previous visit to the main website, as shown in FIG. 5. The list could then be viewed by the user on the movie home page 200 as a history of movies of possible interest to the user. The Remember Engine may, for example, be implemented in software routines.

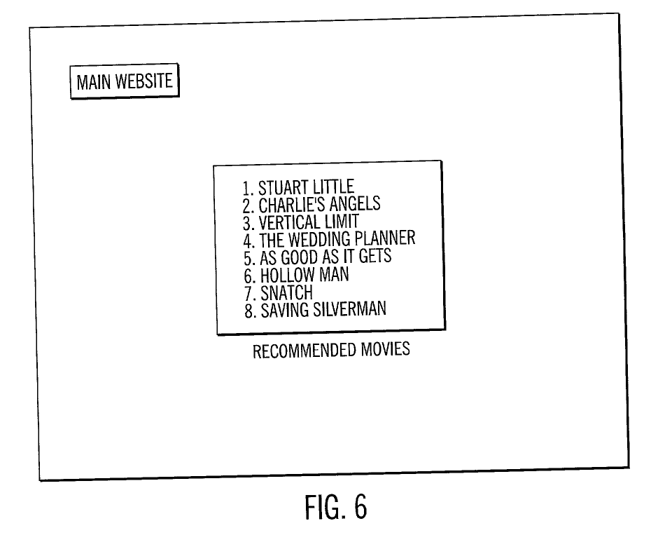

Similarly, in one embodiment, a “Recommendation Engine” may be used to customize the movie home page 200 or other pages. The Recommendation Engine may, for example, be implemented in software routines that provide the user with suggestions of movies to download, as shown in FIG. 6. In one embodiment, the Recommendation Engine will track user activity on the main website or elsewhere, for example, on other websites, to determine the movie preferences of the user. As an example, the Recommendation Engine may determine from the user's past activity that the user prefers westerns or comedies. Similarly, the Recommendation Engine may determine that the user prefers movies directed by Alfred Hitchcock or another director. In another embodiment, the Recommendation Engine may suggest movies to download based on responses to questions posed to the user on the main website or elsewhere, or based on the user's evaluation of movies. As an example, the Recommendation Engine may query the user about what categories of movies the user likes (westerns, comedies, horror films) or what actors, directors, or time periods (1950's, 1960's ). In yet another embodiment, the Recommendation Engine may make movie suggestions based on a combination of the above-named factors.

The Recommendation Engine and the Remember Engine may also be used for other purposes tailored to a particular user. For example, in some embodiments, a “Push” feature is included for downloading a movie to a user's computer (or storage device) before the user has selected a movie for purchase. When the user wants to purchase a license, the user may then immediately access one of these previously pushed movies without waiting for download to complete.

The Push download may be requested by the user or performed automatically by the movie website without any request from the user. When performed automatically, the main website may download a movie which the user has either previously designated using the Remember Engine or that has been selected for the user by the Recommendation Engine. The designated or selected movie is downloaded even though it was not specifically requested by the user for push download. Thus, no license is purchased at the time of the Push download. The user may later obtain a license to view the movie by activating the movie player software on the user's computer system to play the movie. The user's movie player software contacts the main website and a determination is made as to whether the user has a valid license for playing the pushed movie. Because the user has not yet purchased a license for the pushed movie, the user is prompted to purchase a license. If the user purchases a license, the user may then view the pushed movie according to the terms of the purchased license.

In one embodiment, the user may select several movies for Push download without purchasing licenses for these movies. The main website would then establish a “Push Queue” from which the selected movies would be sequentially downloaded to the user's computer or storage device. In one embodiment, a ‘Smart Push” feature would include the ability to evaluate user settings on the main website and parameters of the user's computer or other storage device, such as available storage capacity, in order to determine whether a particular Push operation should be performed.

The Recommendation Engine may further be used, in some embodiments, to select a trailer or clip of a movie to be played after accessing the user's customized homepage. Thus, the trailer or clip that the user sees upon accessing the main website homepage will be tailored to the user's preferences. Further, extended information such as, but not limited to, movie reviews, ratings, inside industry information (e.g., cast interviews), movie synopsis or production information, links to the Internet Movie Database (IMDB), or the official website for the movie or soundtrack, may be provided to the user based on movies selected by the Recommendation Engine.

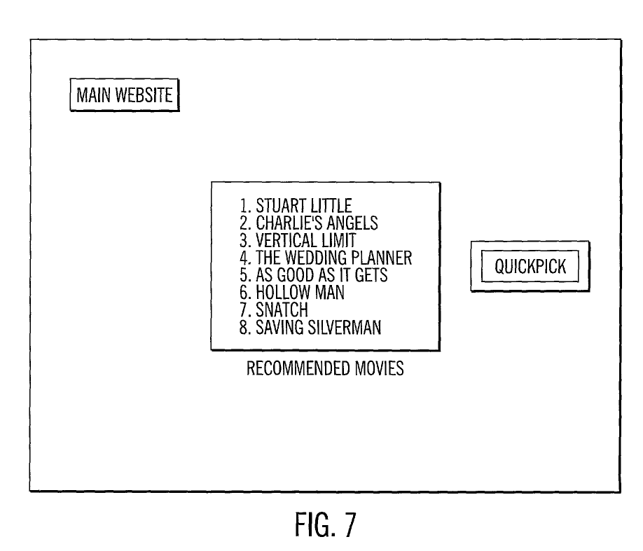

In addition, in one embodiment, a movie selected by the Recommendation Engine may be downloaded to the user in conjunction with a “Quick Pick” feature of the main website, shown in FIG. 7. When a user activates the Quick Pick feature, the Recommendation Engine picks a movie, the main website completes a commercial transaction to purchase a license for the selected movie, and the selected movie is then downloaded to the user.

In other embodiments, the user may also enter into a commercial transaction to purchase a license for rental of the movie by clicking on a video box or selecting a command. In one embodiment, an interface for simple completion of commercial transactions at the main website is provided. A user may complete a transaction, such as a rental, with a single action, such as a mouse-click or keystroke/key combination. If credit card information has already been entered as part of registration, the transaction may avoid repeating the request.

In still other embodiments, this streamlined transaction feature may additionally be available from affiliate websites. Thus, a transaction may be completed on the affiliate website by clicking on an icon for a movie on the affiliate website, confirming a rental transaction, and downloading the movie, without displaying a web page from the main website.

A user may register with the main website through the movie home page 200. Registration provides the user with enhanced access to the services of the main website, such as purchases. Additional services include the open order ticket and a MyList feature, described as follows. The open order ticket provides a user with a listing including one or more digital video signals the user has purchased for rental but has not yet unlocked for view, while the MyList feature, as shown in FIG. 5, provides the user with a listing including one or more digital video signals designated by the user as being of interest during a previous visit to the web site. As discussed above, a list such as MyList may be generated by the Remember Engine. Registration also provides a basis for customization of services to the user. Registration may provide to the main website demographic and marketing information, as well as a basis for tracking user activity.

In some embodiments, demographic information may be used to compile a database of licensing information for various regions (e.g., countries) that may be maintained by the main website. The main website may access the database to provide parameters for available licenses for a movie according to the determined geographical location of a user requesting a movie. The license database may also indicate schedules of release and how licenses adjust as the movie shifts from theatrical release, to pay per view, home video, etc. The main website uses the license information to determine what movies are available at a particular time for a particular place and under what conditions (e.g., cost, duration, method of download, media classification). The determined availability may provide a basis for recommendations to users (e.g., alternatives or similarly priced movies).

The licensing information may also be used for accounting to third parties, such as the studio owning the movie or an actor appearing in the movie. The geographical location of the user may be determined from one or a combination of factors, including the credit card supplied to the main website, the Internet Protocol (IP) address of the user's computer system, geographical information provided by the operating system of the computer system, or certified Global Positioning System (GPS) data from the user's computer system or other storage device.

In some embodiments, marketing information obtained from user registration may be used to determine other websites visited by the user. This information may then be used to develop relationships with affiliate sites which may provide links to the main website. The link may be to the main website home page or to a page for a specific movie available through the main website. A benefit, such as a percentage of the proceeds from each movie rental derived from access through the affiliate website, may then be given to the affiliate website.

In further embodiments, coupons for discounts and rebates on services offered by the main website or affiliate websites may be offered to the user as promotional gifts or rewards for referrals, multiple downloads, or non-download transfers (discussed below). Coupons may also be offered for a purchase, such as the digital video disc (DVD) for a movie, at an affiliate site from which the user entered the movie website. The coupons may be tailored to the information derived from the user in the registration process.

In yet another embodiment, licenses for “Movie Bundles” may be offered to the user based on user registration information. A Movie Bundle may be a group of movies for which licenses may be purchased together at a discount. The bundles may be defined by the movie website for specific movies, genres, numbers of movies, or the movie website may provide an interface to the user for designing a bundle and determine the cost of the needed licenses.

In still another embodiment, a newsletter may be sent to users as email. Users may subscribe to one or more newsletters. The movie website may send newsletters to users generally or to selected users. Newsletters may be tailored to the user based on information such as, but not limited to, user registration information or information derived from the Recommendation Engine, as discussed above. The newsletter informs the user of events at the movie website or promotional activities, coming attractions, etc. The newsletter may be customized. The newsletter may include a link to a movie on the movie website or to a streamlined transaction to provide a download directly from the newsletter.

In addition, community information may be posted by the user on the main website. Users may supply information to the movie website to be viewed by other users, such as forums, reviews, fan art or stories, etc. Users may communicate in real-time, such as in conjunction with a streaming download being viewed by multiple users. Community information may also provide a chat interface. Movie exchanges between users may be facilitated on the chat interface, for example, by communication of download information for a user's particular machine from one user to another. Movies may then be downloaded directly from a first user's machine to a second user's machine.

The second user may then purchase a license for the movie by activating the movie player software on the second user's computer system to play the movie. The second user's movie player software contacts the main website and a determination is made as to whether the second user has a valid license for playing the downloaded movie. Because the second user has not yet purchased a license for the downloaded movie, the user is prompted to purchase a license. If the user purchases a license, the user may then view the pushed movie according to the terms of the purchased license.

A browse page as described in further detail below, may be accessed from the movie home page. The browse page provides access to all the movies available on the server. The movies may be organized in various ways, such as by title, genre, license cost, or download time. The movies may be displayed in various ways as well, such as in text lists, image lists, video box lists, grids, or stacks. One manner of displaying movies is in a horizontal row of video boxes, which may be caused to slide to the left or right, simulating the action of a carousel. A user may interact with the movies presented on the browse page in the same way as those movies presented on the home page.

A search page may also be accessed from the movie home page 200. A user may search within the available movies of the main website according to various criteria, such as title, actor, director, producer, date, genre, license cost, or download time. The results of the search may be presented in various formats as well, similar to the movies presented on the browse page. Again, a user may interact with the movies presented on the search page in the same way as those movies presented on the home page.

The main website may also provide movie pages. A movie page is a web page serving as an access point to information about a movie. A movie page may include various information and functions, such as commercial transaction requests, or the additional information described above. A movie page may be accessed by selecting a movie and requesting the movie home page for the movie. The movie page presentation may provide a more consolidated and discrete presentation of information, rather than large amounts of information for multiple movies on a single page.

As described herein, a trailer refers to a clip (video segment) or collection of clips from a movie played when a user enters the main website or selects a movie in the main website. As described herein, virtual video boxes refers to a collection of images from a video cassette box forming an online graphical representation of virtual box of a video box. The image may be a direct image of the art and text on the physical box used for home video release, or may be a special online version. The carousel interface provides multiple virtual boxes or images presented in one or more rows which may be moved by the user. The boxes slide sideways with a continuously animated action and variable speed to simulate a rack or carousel being rotated before the user, including a continued rotation (or momentum) prior to coming to a complete stop. Alternatively, rotation of the multiple rows of boxes provides a user with a simulation of walking along racks of VHS video boxes along aisles within a video rental store. In some embodiments, the user may view the front and back of the box, or manipulate the virtual box in 3D for rotation.

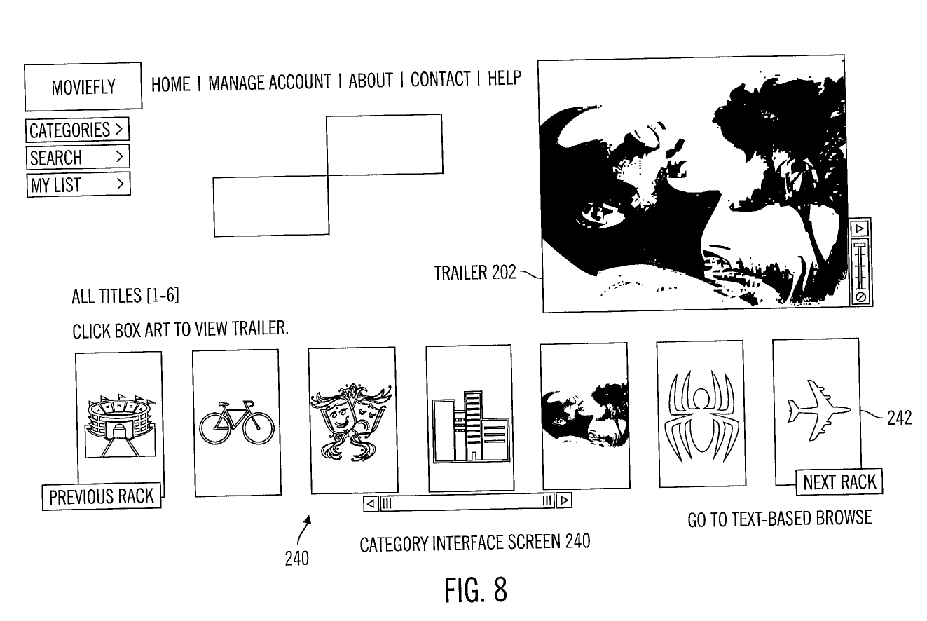

FIG. 8 is a further exemplary online video transfer site screen that allows online users to participate in online rental of digital video signals. According to one embodiment, when an online user makes a request the search and browse digital video signals available for online rental category interface screen 240 is presented. In accordance with one embodiment, the digital video signals are digitally encoded motion pictures such that information regarding each digitally encoded motion picture appears as a virtual video box including original box art as appears on a VHS version of the video box. Using the user interface procedures 156, the category interface screen 240 enables viewing of online category information stored in the catalog database 160. The category interface screen 240 enables scrolling rows of virtual box art one at a time or in a group within the carousel interface 242, such that movie rental from carousel of movies or from aisles of a video rental store is simulated. In addition, rows of virtual box art may be sorted based on sort criteria provided by the user to a movie search engine of the network server video computer 130. Advantageously, in this manner, the category interface screen 240 simulates movie rentals from racks of aisles within a video rental store.

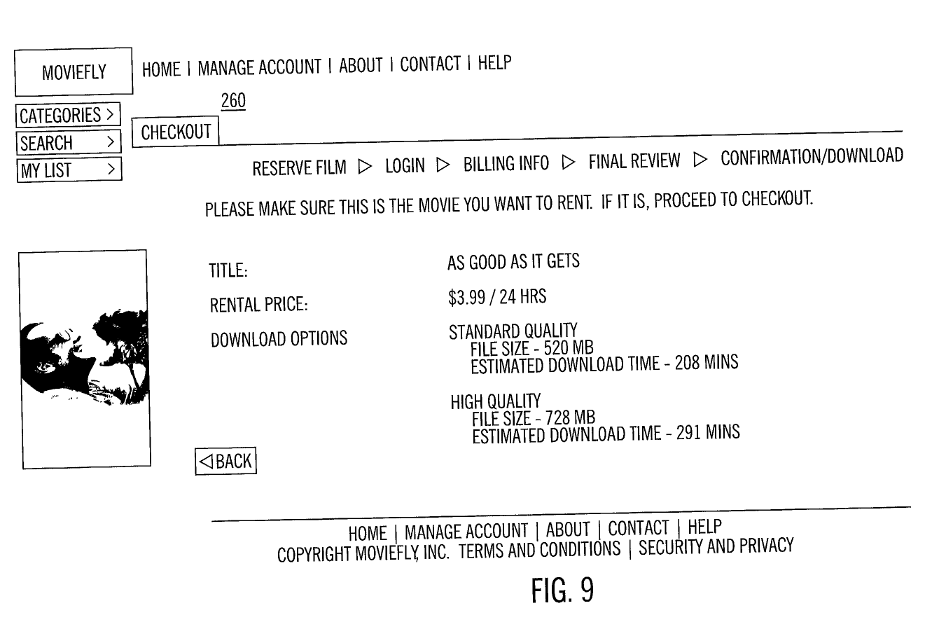

FIG. 9 is a further exemplary online video transfer site screen that allows online users to participate in online rental of digital video signals. According to this embodiment, when an online user selects a digital video signal for rental, checkout screen 260 is presented. Using the price calculation procedures 154, the checkout screen 260 calculates and receives electronic payment from the user for the selected digital video signal thereby granting the user a license to view the selected digital video signal for a specified period of time. The checkout screen 260 provides an interface for a commercial transaction, such as a form to be completed or queries to the user for credit card information and confirmation of billing to the user's credit card. The specified period of time may be a twenty-four hour period, which commences once the digital video signal is unlocked as further described below. Alternatively, the specified period of time may commence once downloading of the digital video signal is complete.

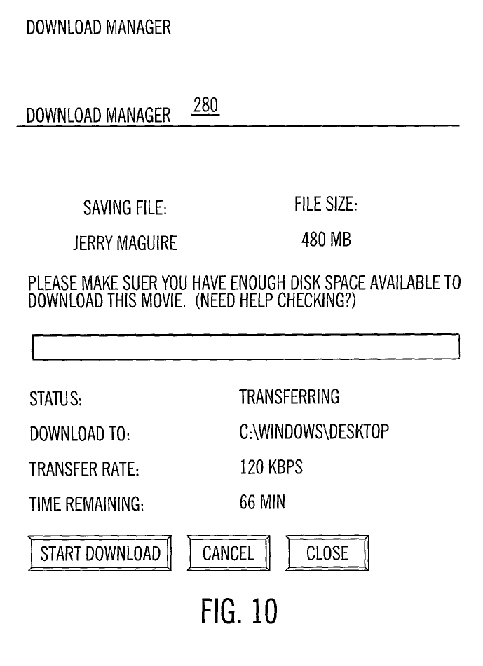

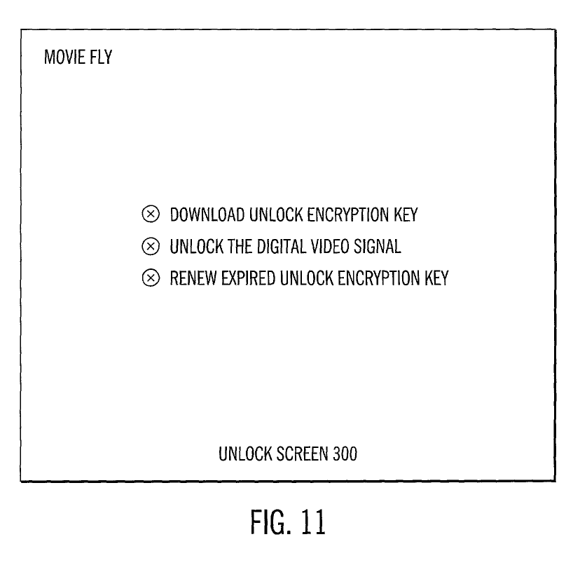

Once electronic payment is received, download screen 280 is presented as depicted in FIG. 10. The download screen provides users with the information regarding the file name and storage location for the downloaded digital video signal including the file size and duration time of the download. Using the video delivery procedures 150, the network video server computer 130 downloads an encrypted version of the digital video signal to the user computer 102. Once the user has downloaded the selected digital video signal, the user may view the selected digital video signal using the video media procedures 118, such as a Windows media player (movie player software 118). The movie player software 118 contacts the network video server computer 130 to verify that the user has a proper license for the selected digital video signal at which time an unlock screen 300 is presented as depicted in FIG. 11. In one embodiment, the unlock screen offers an online user the following options: (1) download an unlock encryption key; (2) unlock the digital video signal to enable viewing; and (3) renew an expired unlock encryption key. The unlock screen 300 provides an unlock encryption key enabling the movie player software 118 to produce a user-perceptible form of the selected digital video signal (i.e., to play a movie viewable by the user) during the specified period of time. The user may control playback similar to a VCR or DVD player utilizing pause, rewind, as well as other commands.

License Access Levels

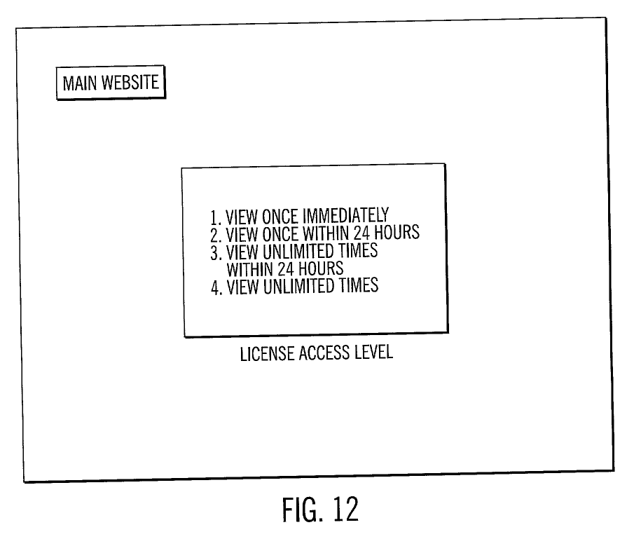

In some embodiments, an interface may be provided so that the user may select a license access level. Licensed access to encoded digital files may be defined in levels, such as “view once immediately,” “view once during a window (e.g. 24 hours),” “view unlimited times during a window,” and “view unlimited times,” as shown in FIG. 12. A user may upgrade a license at a reduced cost relative to an initial purchase. For example, a user may initially purchase a license to view a movie during a 24 hour window and subsequently upgrade that license in order to view the movie an unlimited number of times during the 24 hour window. A license discount may also be provided based on a previously purchased and narrower license for the same movie. Alternatively, the main website service operator may select an access level for a user, a group of users, or all users from the above listed levels and may then change the selected level as the operator deems appropriate. In other embodiments a license may be purchased or granted where the movie is viewed on a machine other than the machine to which the movie was downloaded.

Further, a license for a movie may be purchased as a gift certificate. A gift certificate may be purchased by a first user to grant access to a second user. The first user may purchase the license for the second user with or without downloading the movie. If the first user does not download the movie at the time of purchasing the license, the first user may, for example, be provided with a password to give to the second user that will allow the second user to download the movie to the second user's system or device.

In one embodiment, authentication of the license is based on a key derived from the user's computer system (or other storage device) and from the movie. The key may also include further information such as, but not limited to, time of download, location of the user's device, and the user's specific movie player. Also, in some embodiments, the key information may be included in the downloaded movie. Thus, the movie, or copies of the movie, maintain the key information and access level information determined by the purchased license, if any. Thus, in these embodiments, once the second user has downloaded the movie to the second user's system or device, the license may only be authenticated for that system or device.

Therefore, after the second user has downloaded the selected movie or received the movie tangibly encoded onto portable storage media and wishes to view the movie, the second user may activate the movie player software on the second user's system or device, at which time the main website will be contacted to verify that the second user has a proper license for the selected movie. The second user may then access the movie in accordance with the license purchased by the first user, but the first user would not have access to the movie. If a gift certificate license was not purchased by the first user, the second user will be prompted to purchase a license.

Alternatively, if the first user downloads the selected movie to the first user's system or device at the time of purchasing the license, the first user will again, for example, be provided with a password to give to the second user. The first user may then transfer the movie to the second user's system or device, for example, by a portable storage media such as a compact disc. Thus, after transferring the movie from the first user's system or device to the second user's system or device, the second user will then be required to provide the password to the main website in order to allow the second user to receive a new license to play the movie on the second user's system or device without paying another license fee. The main website may ensure that the movie key is unlocked only on the second user's system or device by canceling the first user's license before revealing to the first user the password for the second license.

Further, in other embodiments, a “Flexible Viewing” feature would be included which enables the user's movie player to track the progress through the movie playback and to update licensing information to indicate that playback has not yet been completed. When the user later attempts to access the movie to continue viewing, the license verification confirms that the movie has not been completely viewed yet. Thus, the user is allowed to view a movie in multiple sessions without purchasing additional licenses. Additional information may be included to track rewind, amount of time spent viewing, or other factors to control abuse.

In further embodiments, a user may maintain a “Movie Library.” The Movie Library may be a collection of movies for which the user has unlimited access. A user may purchase a license which allows the user to access the movie an unlimited number of times from different machines or storage devices. Thus, at this license level, it as though the user had a portable physical manifestation of the movie, such as a DVD.

The user or other users may access the Movie Library from any Internet access point, subject to possible downloads. If the user transports a physical copy of a movie within the user's Movie Library to a different machine, the download time may be avoided and only the license verification need occur. Collateral movies may be included in the same license purchase (e.g., one purchase provides a license for the same movie stored in different encoding formats for different download time and image quality).

In one embodiment, the Movie Library is a “Dynamic Library.” As encoding technology improves, the same amount of storage space may provide a higher quality image. A Dynamic Library allows a user to receive the latest version of the encoded file for the best image quality available. Thus, if an alternative version of a movie is made available, the Dynamic Library may update to that version.

In further embodiments, an “Archive Management System” is implemented to control abuse of files stored on the user's computer system or other storage device. Thus, the ability to interact with the file system on the user's storage device may be included as part of the main website. This may be accomplished, for example, in cooperation with client software active on the user's storage device. The archive management system may be used for purposes such as, but not limited to, enforcement of licenses through the removal of downloaded movies which do not have valid licenses or which have been abused. As an example, if movie files on the user's storage device have been tampered with in some way, for example by attempts to bypass the encryption key within the movie file, the Archive Management System may detect such abuse and may override other file management software on the user's storage device to delete the abused movie files. In another embodiment, the Archive Management System will determine if a movie was received from another user (for example, by a client to client download) and prompt the user to purchase a license in order to view the movie.

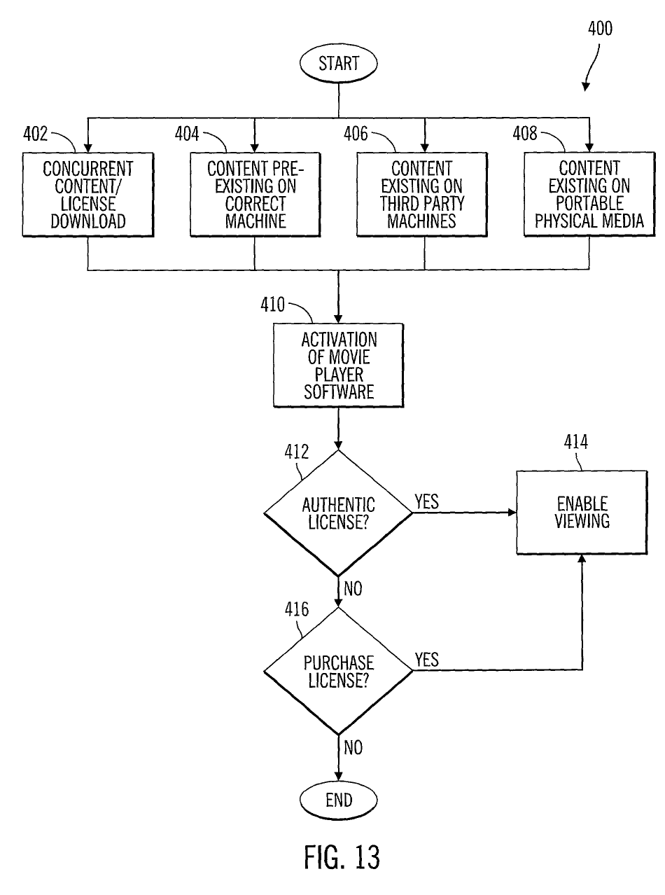

Referring now to FIG. 13, a method 400 is depicted for obtaining a license for rental of digital video signals within an online environment, for example, in the online digital video signal transfer apparatus 110 as depicted in FIG. 1. Steps 402 through 408 illustrate some of the ways that a user may obtain content which he may then wish to access through the use of a valid license.

At step 402, the user has downloaded content from the network server computer to the user's computer while concurrently purchasing a license for the content. Authentication of the license may be based on a key derived from the user's computer system (or other storage device), the user's movie player software, or from the content. The key may also be authenticated based on a combination of information derived from these sources. Thus, under the circumstances illustrated in step 402, when the user activates the movie player software at step 410, the user will contact the main website and the license that was purchased when the content was downloaded to the user's computer will be authenticated if the key contains the expected information.

As an example, if the user downloaded the content to the user's machine and the key was based on information derived from that machine, then the user's license is authenticated at step 410 as long as the user is activating the movie player software on the same computer, because the information contained in the key matches the expected information. Thus, the user could proceed to step 414 and could view the content. However, if the content that was downloaded to and matched to the user's computer was then transferred to another computer, when the user of that computer activates the movie player software at step 410 and contacts the main website, the license is not authenticated because the key does not contain the expected information. Thus, the user proceeds to step 416 and is prompted to purchase a valid license for the content. If the user purchases a license, the user proceeds to step 414 and can view the content.

As described above, the key may also be based on the content. Thus, in the case of content that is part of the user's Movie Library, i.e. movies for which the user has obtained a license with which the user may access the movies from any Internet access point, when the user activates the movie player software at step 410 and contacts the main website, the license is authenticated because the key is based on the content and not on a particular computer system or movie player software.

At step 404 in FIG. 13, the user has pre-existing content on the user's computer system or other storage device. The pre-existing content may have been on the system when the system was purchased by the user, for example, as part of a promotional campaign. Under the circumstances illustrated by step 404, the user will not yet have purchased a license for the pre-existing content. Thus, when the user activates the movie player software at step 410 and contacts the main website, the license is not authenticated. The user therefore proceeds to step 416 and is prompted to purchase a valid license for the content. If the user purchases a license, the user proceeds to step 414 and can view the content.

At step 406 in FIG. 13, the user is a third party user, i.e., the third party user is not the person who originally downloaded the content from the network server computer. The third party user may have obtained the content, for example, by downloading it from a first user's computer system or other storage device. The third party user may also have transferred the content from the first user's system to the third party user's system by means of portable storage media. The first user may or may not have previously purchased a license for the content. The third party user may have also obtained the content by downloading it from an affiliate website without purchasing a license from the main website.

Under the circumstances illustrated by step 406, the third party user has not yet purchased a license for the content. As discussed above, authentication of the license may be based on a key derived from the user's computer system (or other storage device), the user's movie player software, or from the content. Thus, if the first user purchased a license and if the key is based on the first user's computer system or movie player software, the third party user does not have a valid license to view the content on the third party user's computer system. If the first user did not purchase a license, then, of course, the third party user will not have a valid license either. Therefore, at step 412, the license will not be authenticated and the third party user proceeds to step 416 and is prompted to purchase a valid license for the content. If the third party user purchases a license, the third party user proceeds to step 414 and can view the content.

At step 408 in FIG. 13, the user has portable physical media which contains content derived from the network server computer. The user may have received the portable storage media from another user. The user may also have received the portable storage media via the main website or from another website, for example, as part of a promotional campaign.

Under the circumstances illustrated by step 408, the user has not yet purchased a license for the content. Thus, when the user activates the movie player software at step 410 and contacts the main website, the license is not authenticated. The user therefore proceeds to step 416 and is prompted to purchase a valid license for the content. If the user purchases a license, the user proceeds to step 414 and can view the content.

Downloading Of Encoded Digital Files

In one embodiment, the user may download the encrypted digital files directly to the user's computer system or other storage device. However, in another embodiment, the user may also choose to download to a remote storage device. Thus, a user may specify a storage device for download different from the computer system or other device with which the user is accessing the main website. As an example, the user may access the main website from an office device and download a movie to the user's home device.

In another embodiment, the movie would be viewable during the download process. Thus, the movie may be viewed from memory such as, but not limited to, RAM, or, with a delay, a hard disk, before the file has been completely downloaded.

Downloading from the main website involves certain costs in resources, time, and maintenance. Accordingly, incentives, such as coupons and other rewards discussed above, are offered to users to take advantage of certain download avoidance methods. In one embodiment, a first user may transfer a previously downloaded encoded digital file from a first device to a second device belonging to a second user. The second user may then obtain a license to access the encoded digital file. In this way, a second downloading process and its associated costs to the main website are avoided. In this embodiment, the second user will be prompted to purchase a license in order to view the movie.

In further embodiments, the main website will include a “Movie Share” feature. A list of movies previously downloaded by a first user may be posted on the main website . Other users may access the list and download movies directly from the first user's device. A license may subsequently be purchased from the main website without downloading the movie itself from the main website. Again, the Movie Share feature avoids a second downloading process and its associated costs to the main website.

In further embodiments, the main website will include a “Smart Download” feature. The Smart Download feature could download a digital file using a preferred channel and time. The preferred channel may be determined in agreement with user-supplied parameters, possibly at the suggestion of the movie website. Because the movie website has access to scheduling information for all downloads to occur, the main website may predict what time and channel will be most efficient in terms of speed, cost, and bandwidth use. For example, when a new movie becomes available on the movie website which is known to be a very popular movie, the movie website may assume that traffic will be heavy and provide downloads over multiple channels, such as the Internet and satellite broadcast. Users will be assigned a download channel and time according to a best effort to accommodate the user in light of the current situation. Similarly, the movie website could provide a download through broadcast, such as satellite, as part of a promotional activity and sell licenses for those downloaded movies at a discount.

In further embodiments, the main website may offer a “Flexible Rental” feature. The cost of a rental license could be based on the cost of a requested download or use. For example, various discounts may be provided which reflect reduction in resource costs to provide the movie to the user by avoiding download costs. By allowing the movie website to download the movie over a slower connection or at low traffic time, the user may receive a discount. The user may also receive a discount by purchasing a license for access sometime in the future. In addition, the user may receive a discount by purchasing a rental license again within a period of time after a previous rental of the same movie.

In further embodiments, a user may download a digital file to a portable storage media. For example, the user may purchase a license allowing a downloaded file to be stored on and accessed from a portable media, including, but not limited to, CD-R, CD-RW, or DVD. The DVD may be a standard DVD encoding or may still require license verification from the main website to be accessed.

In further embodiments, the main website may include a “Download Interruption Recovery” feature. An interruption may occur, for example, because of a network or power failure. Download Interruption Recovery would ensure the resumption or retransmission of an interrupted download process. The main website may track download progress and resume the download to complete the transfer or begin the transfer anew.

Operation

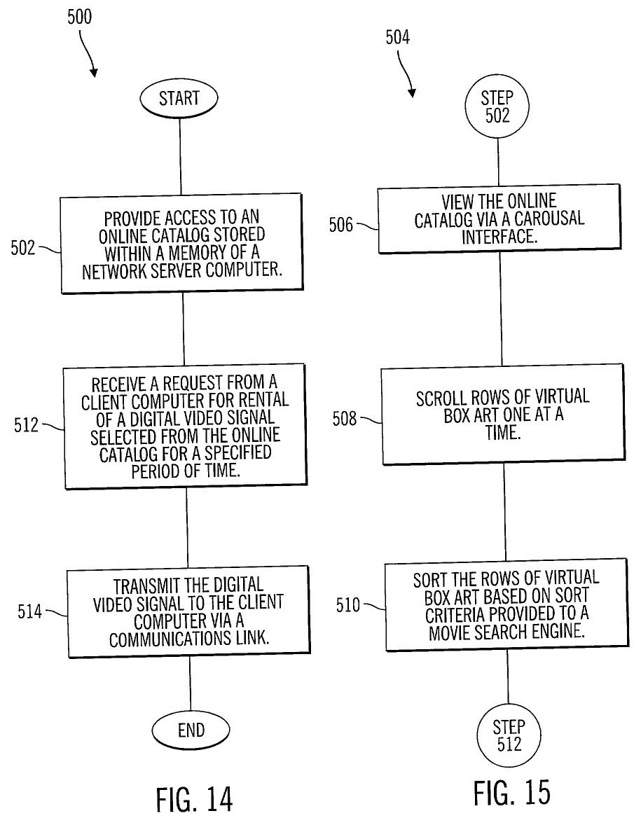

Referring now to FIG. 14, a method 500 is depicted for rental of digital video signals within an online environment, for example, in the online digital video signal transfer apparatus 110 as depicted in FIG. 1. At step 502, access is provided to an online catalog stored within a memory of a network video server computer 130 such as for example, the catalog database 160. The online catalog includes information regarding digital video signals available for rental from the network video server computer 130. At step 512, a request is received from a client computer 102 for rental of a digital video signal selected from the online catalog for a specified period of time. The request generally includes payment information such as electronic payment by credit card number based on the selected digital video signal and the specified period of time. Finally, at step 514, the digital video signal is transmitted to the client computer 102 via communications link 120. The digital video signal, once downloaded, is viewable by a user of the client computer during the specified period of time which begins once the digital video signal is unlocked as described below. Once the specified period of time is expired, the user must request and make further payments for viewing of the digital video signal for additional specified periods of time.

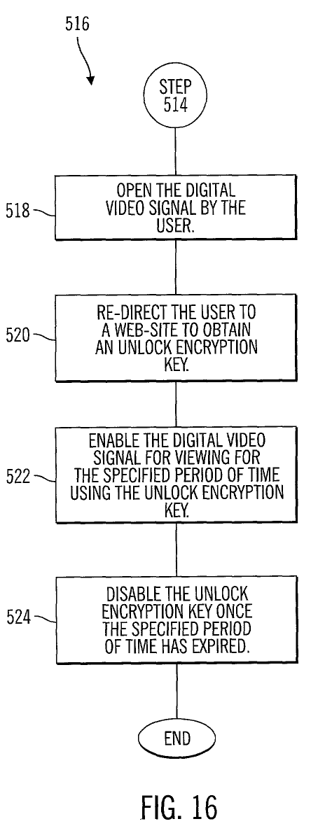

FIG. 15 depicts additional method steps 504 for providing access to online catalog information stored within the catalog database 160 of step 502, for example, in the category interface screen 240 as depicted in FIG. 8. At step 506, the online catalog is viewed via carousel interface 242 such that information regarding each digital video signal is presented within one or more vertically rotatable rows. In accordance with a further embodiment, the digital video signal is a digitally encoded motion picture, such that information regarding each digitally encoded motion picture appears as a virtual video box including original box art as appears on a VHS version of the motion picture box. At step 508, one or more rows of virtual box art are scrolled in a sliding, sideways manner one at a time or in a group, such that movie rental from a carousel of movies or from aisles of a video store is simulated. Finally, at step 510, the rows of virtual box art may be sorted based on sort criteria provided to a movie search engine of the network video server 130.

FIG. 16 depicts additional method steps 516, such that the digital video signal is encrypted prior to transmission to the client computer 102. At step 518 the digital video signal is opened by the user using the movie player software 118. At step 520 the user is redirected to a website to obtain an unlock encryption key such as the unlock screen 300 (FIG. 11) in accordance with the rental procedures 152. In one embodiment, the server 130 checks whether an unlock encryption key has been issued or activated for the movie to be accessed and requires a new license to be purchased to obtain additional keys. In accordance with the rental procedure 152, the unlock key becomes associated with the client machine 102, for example, through a system file of the client computer and data stored on the server 130 indicating the key and the downloaded copy of the movie. Association of the unlock key with the client computer 102 prevents users from copying the unlocked digital video signal to several computers for unlicensed usage.

At step 522 the digital video signal is enabled for viewing in accordance with the terms of the purchased license, for example, for a specified period of time using the unlock encryption key, such that the unlock key stores the time at which it was unlocked and initiates the specified period of time for rental. In one embodiment, the unlock encryption key may be activated at any time after being downloaded from the server 130. In this case, the time period does not begin until the key is activated. In addition, the unlock key stores a machine identifier such, for example a machine ID of the client computer 102. During the specified period of time, the unlock key verifies that the machine ID of the computer matches the stored machine ID in response to any user attempt to replay the digital video signal. Finally, at step 524, the unlock encryption key is disabled once the specified period of time has expired, thus inhibiting further replaying of the digital video signal. The specified period of time may be a 24 hour period. Consequently, following the 24-hour period, the user is required to obtain an additional unlock encryption key in order to view the digital video signal for a further 24-hour period as described above with respect to the unlock encryption key.

A content database 158 provides storage including electronic video data files such as movies digitally encoded using a conventional encoding scheme such as MPEG 1, MPEG 2 or MPEG 4 in accordance with the content preparation procedures 148. Movies may be provided by one or more movie owners such as movie studios. The files are stored in a secure format such that the digitally encoded motion pictures are encrypted using conventional techniques such as a public-private key system. In addition, watermarks that indicate the source of the specific file may be included as data in the file. A movie file may be examined for a particular watermark, for example by the Archive Management System discussed above, in order to determine whether the movie file is a genuine movie file downloaded from the main website. Thus, watermarks may be useful for license verification as well as controlling piracy.

Several aspects of one implementation of the movie transfer system for providing a movie to a user for viewing have been described. However, various implementations of the movie transfer system provide numerous features including, complementing, supplementing, and/or replacing the features described above. Features may be implemented as part of the server or as part of the user's computer system in different implementations.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed. For example, the particular element may vary depending on the particular application for the novel mixed storage format while maintaining substantially the same functionality without departing from the scope and spirit of the present invention.

In addition, although the embodiment described herein is directed to a video transfer system for enabling online rental of digitally encoded movies, it will be appreciated by those skilled in the art that the teaching of the present invention may be applied to other systems. In fact, systems for online rental of digitally encoded songs, books, television programming, radio programming, and any other content (audio, video, text, etc.) which may be digitized or encoded and stored as an electronic file are within the teachings of the present invention, without departing from the scope and spirit of the present invention.

The present invention provides many advantages over known techniques. The present invention includes the ability to rent motion pictures without having to provide additional monies for purchase of the motion pictures. In addition, the present invention provides an interface which simulates the actual rental of video cassettes or DVDs of motion pictures within a video rental store. Moreover, during the specified period of rental, the user is allowed to view the motion picture as many times as desired, thereby simulating the actual rental of video cassettes or DVDs of feature length motion pictures.

Having disclosed exemplary embodiments and the best mode, modifications and variations may be made to the disclosed embodiments while remaining within the scope of the invention as defined by the following claims.

What is claimed is:

1. A method of delivering content to a network enabled device, the method comprising:
transferring selected content to the network enabled device;
communicating, over a network, a license associated with the selected content to the network enabled device, the license including access level information defining conditions for controlling the network enabled device to produce a user-perceptible form of the selected content when conditions defined by the access level information are met and to inhibit production of a user-perceptible form of the selected content when conditions defined by the access level information are not met.

2. The method recited in claim 1, further comprising:
receiving, at a first node on the network, a request for content from the network enabled device at a second node on the network;
wherein the transferring of selected content comprises transferring the requested content in response to the receipt of the request at the second node.

3. The method recited in claim 1, further comprising:
receiving, at a second node on the network, a request for content from the network enabled device at the first node;
wherein the transferring of selected content comprises transferring the requested content to the network enabled device at the first node, in response to the receipt of the request at the second node.

4. The method recited in claim 2, wherein the license conditions define a time window and a maximum permitted number of times within the window that the content may be provided in user-perceptible form at the second node.

5. The method recited in claim 4, wherein the time window is about 24 hours.

6. The method recited in claim 2, wherein the license conditions permit the content to be provided in user-perceptible form at the second node no more than once immediately after transferring the content.

7. The method recited in claim 2, wherein the license conditions permit the content to be provided in user-perceptible form at the second node no more than once within a time window starting immediately after transferring the content.

8. The method recited in claim 7, wherein the time window is about 24 hours.

9. The method recited in claim 1, wherein communicating a license over the network comprises communicating the license with the selected content.

10. The method recited in claim 1, further comprising providing an interface for allowing a user of the network enabled device to select an access level from a plurality of access levels, each access level defining a different set of conditions, wherein the license associated with the selected content includes access level information corresponding to an access level selected by the user.

11. The method recited in claim 10, wherein the plurality of access levels comprise:
a level defining a time window in which the network enabled device may produce a user-perceptible form of the selected content no more than once; and
a level defining a time window in which the network enabled device may produce a user-perceptible form of the selected content an unlimited number of times.

12. The method recited in claim 10, wherein the plurality of access levels further comprises a level in which the network enabled device may produce a user-perceptible form of the selected content no more than once, at any time.

13. The method recited in claim 10, wherein the plurality of access levels further comprises a level in which the network enabled device may produce a user-perceptible form of the selected content for any specified time period and an unlimited number of times.

14. The method recited in claim 10, wherein the plurality of access levels further comprises a level in which the network enabled device may produce a user-perceptible form of the selected content no more than once, immediately after transfer of the content.

15. The method recited in claim 10, wherein the plurality of access levels further comprises a level in which the network enabled device may produce a user-perceptible form of the selected content no more than once, immediately after communication of the license.

16. The method recited in claim 2, wherein the network comprises a wide area network and wherein receiving a request for content comprises receiving a request communicated over the wide area network.

17. The method recited in claim 2, wherein the network comprises a local area network and wherein receiving a request for content comprises receiving a request communicated over the local area network.

18. The method recited in claim 1, wherein transferring the selected content comprises transferring at least one electronic file.

19. The method recited in claim 1, transferring the selected content comprises transferring at least one encrypted electronic file.

20. The method recited in claim 2, further comprising:
providing an interface for allowing a user at the second node to select at least one content file from a plurality of content files;
wherein the requested content comprises at least one content file from the plurality of content files.

21. The method recited in claim 2, further comprising:
providing an interface for allowing a user at the second node to select at least one encrypted digital video content file from a plurality of encrypted digital video content files;
wherein the requested content comprises at least one encrypted digital video content file from the plurality of encrypted digital video content files.

22. The method recited in claim 2, wherein the request includes payment information for the content.

23. The method recited in claim 22, wherein the payment information comprises an electronic payment.

24. The method recited in claim 1, wherein transferring the requested content comprises communicating the requested content to the second node over the network.

25. The method recited in claim 1, wherein transferring the requested content comprises providing to the second node a machine-readable medium suitable for storing electronic files, having stored thereon the requested content.

26. The method recited in claim 25, wherein providing to the second node a machine-readable medium having stored thereon the requested content comprises providing to the second node a CD-ROM.

27. The method recited in claim 25, wherein providing to the second node a machine-readable medium having stored thereon the requested content comprises providing to the second node a DVD.

28. A system for controlling user access on a user network device to content, the system comprising:
a server network device communicatively coupled to the user network device;
wherein the server network device is programmed to transfer selected content to the user network device, and
wherein the server network device is further programmed to communicate, over a network, a license associated with the selected content to the user network device, the license including access level information defining conditions for controlling the user network device to produce a user-perceptible form of the selected content when conditions defined by the access level information are met and to inhibit production of a user-perceptible form of the selected content when conditions defined by the access level information are not met.

29. The system recited in claim 28, wherein the server network device is further programmed to receive at a first node on the network a request for content from the user network device at a second node on the network;
wherein the transferring of selected content comprises transferring the requested content in response to the receipt of the request at the second node.

30. The system recited in claim 29, wherein the license conditions define a time window and a maximum permitted number of times within the window that the content may be provided in user-perceptible form at the second node.

31. The system recited in claim 28, wherein the server network device is further programmed to provide an interface for allowing a user of the user network device to select an access level from a plurality of access levels, each access level defining a different set of conditions, wherein the license associated with the selected content includes access level information corresponding to an access level selected by the user.

32. The system recited in claim 31, wherein the plurality of access levels comprise:
a level defining a time window in which the user network device may produce a user-perceptible form of the selected content no more than once; and
a level defining a time window in which the user network device may produce a user-perceptible form of the selected content an unlimited number of times.

33. A method of acquisition of content by a network enabled device, the method comprising:
receiving selected content at the network enabled device;
receiving, by communication over a network, a license associated with the selected content, the license including access level information defining conditions for controlling the network enabled device to produce a user-perceptible form of the selected content when conditions defined by the access level information are met and to inhibit production of a user-perceptible form of the selected content when conditions defined by the access level information are not met.

34. The method recited in claim 33, further comprising:
submitting, to a first node on the network, a request for content from the network enabled device at a second node on the network;
wherein the receiving of selected content comprises receiving the requested content in response to submitting the request at the second node.

35. The method recited in claim 33, further comprising:
submitting, to a second node on the network, a request for content from the network enabled device at a first node on the network;
wherein the receiving of selected content comprises receiving the requested content in response to submitting the request at the first node.

36. The method recited in claim 34, wherein the license conditions define a time window and a maximum permitted number of times within the window that the content may be provided in user-perceptible form at the second node.

37. The method recited in claim 33, further comprising accessing an interface for allowing a user of the network enabled device to select an access level from a plurality of access levels, each access level defining a different set of conditions, wherein the license associated with the selected content includes access level information corresponding to an access level selected by the user.

38. The method recited in claim 37, wherein the plurality of access levels comprise:
a level defining a time window in which the network enabled device may produce a user-perceptible form of the selected content no more than once; and
a level defining a time window in which the network enabled device may produce a user-perceptible form of the selected content an unlimited number of times.

39. A system for acquiring user access to content controlled by a server network device, the system comprising:
a user network device communicatively coupled to the server network device;
wherein the user network device is programmed to receive selected content at the user network device, and
wherein the user network device is further programmed to receive, by communication over a network, a license associated with the selected content at the user network device, the license including access level information defining conditions for controlling the user network device to produce a user-perceptible form of the selected content when conditions defined by the access level information are met and to inhibit production of a user-perceptible form of the selected content when conditions defined by the access level information are not met.

40. The system recited in claim 39, wherein the user network device is further programmed to submit to a first node on the network a request for content from the server network device;
wherein the user network device submits the request at a second node on the network and wherein receiving of selected content comprises receiving the requested content in response to submitting the request at the second node.

41. The system recited in claim 40, wherein the license conditions define a time window and a maximum permitted number of times within the window that the content may be provided in user-perceptible form at the second node.

42. The system recited in claim 39, wherein the user network device is further programmed to access an interface for allowing a user of the user network device to select an access level from a plurality of access levels, each access level defining a different set of conditions, wherein the license associated with the selected content includes access level information corresponding to an access level selected by the user.

43. The system recited in claim 42, wherein the plurality of access levels comprise:
a level defining a time window in which the user network device may produce a user-perceptible form of the selected content no more than once; and
a level defining a time window in which the user network device may produce a user-perceptible form of the selected content an unlimited number of times.

44. A business method for controlling distribution of content to a network enabled device, the method comprising:
transferring selected content to the network enabled device, the selected content being supplied by a content owner;
communicating, over a network, a license associated with the selected content to the network enabled device, the license including access level information defining conditions for controlling the network enabled device to produce a user-perceptible form of the selected content when conditions defined by the access level information are met and to inhibit production of a user-perceptible form of the selected content when conditions defined by the access level information are not met; and
charging a license fee to a user of the network enabled device based on a license access level.

45. The business method recited in claim 44, wherein charging the license fee to the user of the network enabled device comprises providing an interface for allowing the user of the network enabled device to select the license access level from a plurality of license access levels, each license access level defining a different set of conditions, wherein the license associated with the selected content includes access level information corresponding to the license access level selected by the user.

46. The business method recited in claim 45, wherein the plurality of access levels comprise:
a level defining a time window in which the network enabled device may produce a user-perceptible form of the selected content no more than once; and
a level defining a time window in which the network enabled device may produce a user-perceptible form of the selected content an unlimited number of times.

47. The business method recited in claim 44, further comprising paying to the content owner a percentage of the license fee charged for the license associated with the selected content.

48. The business method recited in claim 44, wherein demographic information associated with the license is used to compile a database of licensing information for various regions.

49. The business method recited in claim 48, wherein the database provides a plurality of parameters for available licenses for the content according to the determined geographical location of the user requesting the content.

50. The business method recited in claim 49, wherein the plurality of parameters comprises at least one of availability of the content at a particular time and availability of the content at a particular geographical location.

51. The business method recited in claim 48, wherein the licensing information is provided to content owners.

52. The business method recited in claim 49, wherein the geographical location of the user is determined from at least one of the user's credit card information, an IP address of the user's computer system, and geographical information provided by the operating system of the user's computer system.

53. The business method recited in claim 44, further comprising providing benefits to the user under defined circumstances.

54. The business method recited in claim 53, wherein the benefits comprise charging a reduced license fee for the content.

55. The business method recited in claim 53, wherein the benefits comprise coupons for purchase of merchandise.

56. The business method recited in claim 53, wherein the defined circumstances comprise at least one of promotional gifts to the user, rewards to the user for referrals, rewards to the user for multiple downloads of the content, rewards to the user for non-download transfers of the content, and rewards to the user for purchasing a bundle of the content.

57. The business method recited in claim 44, wherein charging a license fee comprises receiving payment information from the user of the network enabled device.

58. The business method recited in claim 57, wherein the payment information comprises the user's credit card information.
